(19) United States
(12) Patent Application Publication
(10) Pub. No.: US 2006/0233685 A1
(43) Pub. Date: Oct. 19, 2006

(54) Non-aqueous method for separating chemical constituents in spent nuclear reactor fuel

(76) Inventor: Clarence W. Janes, Sacramento, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/107,036

(22) Filed: Apr. 15, 2005

(51) Int. Cl. C01G 56/00

(52) U.S. Cl. 423/3; 423/5; 423/19; 422/198

(57) ABSTRACT

Herein is a method of segregating chemical species contained in spent nuclear reactor fuel without employing conventional acid dissolution. Particularly, pellets of spent fuel are ground to talc sized particles. Heat is added. The preferred heating is by flow through a plasma arc producing micron sized liquid drops suspended in helium flow. The vapor pressure of the chemical species is significantly greater than uranium dioxide. the ultra volatile chemical species evolve from the drops into the helium flow. The gas phase is separated from the mist by a gas/liquid separator (demister). Heavy mist drops of UO₂ impact the walls, coalesce and flow down to the separator drain, becoming legally transportable. Helium flow exhausts from the separator vertically. The gaseous chemical species will condense in sequentially cooler stages and separate from the helium down to the cryogenic temperatures of liquid radioactive xenon and krypton. Non-condensed helium is recycled.

### FIELD OF THE INVENTION

This invention pertains generally to reducing risk in the disposition of spent nuclear reactor fuel, and more particularly to the reduction of spent nuclear fuel into chemical constituents, achieving a physical separation of the radioactive elements from the inert, often valuable, non-radioactive or low level radioactive, transportable majority of the material. More particularly, this invention relates to unique separation methods and apparatuses which make use of the greater vapor pressures at elevated temperature of the chemical species generated from the many neutron interactions than that of the remaining unreacted spent uranium dioxide.

### BACKGROUND OF THE INVENTION

From successful operation of the world's first nuclear reactor in December 1942 it was realized that an efficient separation process was urgently needed. Of primary importance at that time was collection of plutonium, produced by the neutron interaction with natural uranium U²³⁸. The new method developed at that time for plutonium recovery was based on wet chemistry and dissolution of the spent fuel in nitric acid, together with an organic phase solvent-extraction method. The “PUREX” (Plutonium/URanium EXtraction) is still used exclusively in all the world's spent nuclear fuel reprocessing plants. The PUREX process requires a large central chemical facility equipped with expensive hot cells, extensive liquid storage and requires transport of the spent fuel from the security of the individual nuclear power plants. A major drawback of the PUREX process is the production of large volumes of low level liquid radioactive wastes. This invention achieves the chemical separations required and does so with no liquid or chemical additions.

Nuclear power plants are in use worldwide and currently produce ˜16% of the world's supply of electricity; 20% of U.S. electricity. Nuclear power plants function by the violent process of neutron induced fission, predominantly of the U²³⁵ isotope of uranium. Approximately one-third of the heat produced from the fission process in the reactor is converted from heat to electricity via a conventional steam cycle. Natural uranium contains only 0.711% of the fissionable isotope U²³⁵. Certain types of reactors can operate for a limited time fueled with natural uranium. The uranium fuel employed in the most common reactor designs has been enriched in the fissionable isotope. The natural uranium is enriched to be 3% to 5% U²³⁵ in a gaseous diffusion process. The use of enriched fuel enables the nuclear power plant to operate for an extended period, i.e. until the U²³⁵ content is spent and has fallen to an inoperable level of about 0.92%. The enriched fuel allows the typical nuclear power plant to release approximately 33,000 thermal megawatt-days of heat energy from a single metric ton of enriched uranium. A nominal 1,000 megawatt-electric nuclear power plant is about 33.3% thermally efficient in converting heat to work. The nominal plant is therefore seen to operate at 3,000 thermal megawatt heat release rate and will generate one metric ton of spent uranium fuel every 33,000/3,000 or eleven days of operation. This calculates to be 8.35 pounds of spent nuclear fuel generated each hour of plant operation. A nuclear plant typically refuels every eighteen months. If for example the reprocessing of the spent fuel is carried out during the month dedicated to refueling the reactor, the design spent fuel reprocessing rate would be about 150 pounds per hour. It will be shown that this invention will readily allow operation at this flow rate to allow location of the separation unit on the premises of the power plant.

Approximately fifty tons of spent uranium fuel is removed from the reactor during reprocessing and the reactor refueled with fifty tons of fresh enriched uranium fuel. The fifty tons of highly radioactive spent fuel is stored underwater adjacent to the power plant facility and is allowed to cool as the radiation level decays with time and awaits transport without further processing to a permanent storage repository. This refueling method is employed at every one of the 104 nuclear power plants now operating for four decades in the U.S. This design concept is termed “the once-through fuel cycle,” as no attempt is made to recover the chemical constituents contained in the spent fuel.

One such recoverable constituent is plutonium. Approximately one percent of the spent fuel is plutonium, a fissionable element equivalent in fission energy to U²³⁵. One gram of plutonium has the fission energy equivalent to 14.1 barrels of oil and could rightly be so valued if recovered and blended into fresh nuclear fuel and done so within cost. The slight enrichment left in the spent uranium would also reduce natural uranium feed required to the enrichment plant.

Eleven of the twelve “nuclear nations” are reprocessing the spent nuclear fuel and are recycling the recovered plutonium and uranium. Only the U.S. does not reprocess the spent fuel and is currently committed to the “once through fuel cycle” strategy. This decision is understood considering the prevailing economics unique to the U.S., uncertain regulatory cost associated with transporting spent fuel across country, reprocessing plant siting and uncertain long term storage costs of the large volumes of low level nuclear wastes that is generated. Additionally, the current low cost of gaseous diffusion operation needed and to buy and enrich the additional natural uranium outweighs the uncertain net cost benefit of the plutonium recovered. The additional apprehension factor against reprocessing unique to the U.S. is summed up in a recent paper by a prominent government scientist saying “It is difficult to imagine that any form of chemical reprocessing would be more proliferation-resistant than leaving the plutonium mixed with the highly radioactive fission products in the solid fuel matrix.” This invention describes the “difficult to imagine process” that offers even more proliferation-resistance.

Each of the owners/operators of the 104 multi-billion dollar nuclear power plants would store the spent fuel in the adjacent cooling pools until such time as a permanent repository can be identified. Final identification of an acceptable repository has not occurred and the country's spent fuel cooling pools are rapidly filling up. It is agreed by many analysts that regardless of the single choice of the disposal site obtaining nationwide public acceptance will be difficult for the transportation of the spent fuel across the U.S. road and rail network. This perception arises from considering normal transportation accident rates together with the potential for terrorist hijacking and the resulting liability.

After a seventeen year nine billion dollar U.S. Department of Energy (DOE) effort spent on establishing the permanent depository at Yucca Mountain, Nevada, law suits filed in federal courts on behalf of the state of Nevada may stop the DOE effort completely. The cost of the Yucca Mountain project in year 2000 prices is estimated to be $58 billion dollars. The storage capacity will equal the year 2010 total U.S. production of spent fuel, 70,000 tons, such that no room exists for additional fuel generated thereafter, at this expense level. This invention offers an alternative to the Yucca Mountain project and the first practical long-term solution to disposition of spent nuclear reactor fuel.

This invention makes use of the well known fact that approximately 95.5% of the spent fuel is not involved in the fission process and does not require long term storage. The amount of material to be stored according to the prior art is thus correspondingly higher than it would be if the 4.5% involved in the fission process were the only separated and stored material. The spent fuel consists of approximately 95.5% spent depleted uranium in the form of uranium dioxide, and 4.5% other chemical species resulting from the fission process and neutron capture. these other chemical species are believed to be in part in the oxide form. Many of the oxides decompose at elevated temperature. Plutonium dioxide, which is ˜1% of the spent fuel, is the major object of nuclear proliferation concern. The most secure point for the handling of spent fuel is inside the nuclear power plant. Processing during the one month refueling time produces ˜1.6 cubic feet of plutonium dioxide, which can be secured within the facility indefinitely in a manner that makes it secure over the lifetime of the power plant.

Therefore, there is a demonstrated need worldwide for a more economic and effective method for processing the spent nuclear fuel produced in the operation of nuclear reactors. This new method proposed herein would significantly reduce the cost of the world's electricity and effectively end the possibility of the proliferation of plutonium. The present invention details a unique approach to advancing the state of the art and to reduce the associated risk.

### SUMMARY OF THE INVENTION

This invention makes possible more economic and secure processing of spent nuclear reactor fuel within the security of the nuclear power plant site. This is made possible because neither liquid solvents nor wet chemistry or storage for large volumes of radioactive liquids are used nor is any waste generated, and the system can operate with no moving parts. This invention processes the spent fuel by solvent extraction using the mother of all solvents, heat. The low vapor pressure at elevated temperature of the uranium dioxide (95.5% of the spent fuel) relative to the remaining (4.5%) neutron-induced chemical species in the spent fuel mix allows the physical separation to happen. How best to effect this is the subject of this invention.

There are some 50 chemical species generated by the neutron interactions and each exerts its own vapor pressure response to temperature. The melting point of uranium dioxide (UO₂) is 2,847° C. the boiling point is 4131° C. One component of the spent fuel is Strontium which melts at 769° C. and boils at 1384° C. If spent fuel were melted the Strontium would, given enough time, evolve and escape (boil off) the liquid surface as a gas. Further, plutonium dioxide (1% of the fuel) boils at 2800° C. and so would also leave the melted spent fuel as a gas.

Twenty percent of the fission products make up the volatile fraction at room temperature. The volatility of nearly all the chemical species in the spent fuel is much greater than the UO₂ at all temperatures. The chemical species will diffuse through and evolve, driven by their individual vapor pressure, from the solid surface of the UO₂. If the UO₂ is in a molten liquid state the transport to the surface of volatile chemical species is at a greater rate by many orders of magnitude.

The principle this invention is based on is perhaps better understood by analogy. The analogy is to carbon dioxide (CO₂) gas dissolved in cold liquid water under pressure. When the pressure is released the higher vapor pressure CO₂ (M.P. 9° C., B.P. −36° C.) begins to evolve and eventually the water goes “flat.” In a like manner, the 4.5% of non-UO₂ chemical species are dissolved and dispersed in the solid spent UO₂. Minimum drop size and maximum temperature achievable can both increase the rate at which the dissolved gas is evolved from the liquid phase. If for instance, again by way of the example, the same CO₂ saturated in cold water is heated to 100° C. and the water “atomized” in a spray, the rate of CO₂ gas evolution would then, intuitively, be more or less instantaneous. With this understanding of vapor pressure effect, this invention goes on to answer two questions needed to achieve unique processing of spent nuclear fuel: 1) how, in a practical manner, to heat the solid spent fuel to the liquid state; 2) how to produce the smallest practical liquid drop size.

As to the first question, a plasma spray process is preferred, according to this invention. Plasma electric arc technology is known in the art to vaporize and deposit a refractory material heated to vaporization on specific surfaces such as gas turbine blade coatings. This technique is so potent that any material, including tungsten (M. P. 3380° C., B.P. 4889° C.) can be turned to a molten/vapor stream and the sprayed material deposited as a coating on a selected surface. A chemically inert flow of helium and or argon gas is used as the electric conducting plasma gas and carrier of the vaporized or melted material. The ultra effective heating device is referred to as a plasma torch and is in commercial operation worldwide. The material to be melted is fed into the carrier gas and into the plasma arc as a powder typically in the range of 100-micron particle size. This invention employs a plasma torch to heat the carrier gas flow and powdered spent nuclear fuel to the melting point and above, to approximately 3000° C. This is a practical limit considering the refractory materials available for containment. This is the temperature range of the tungsten filament temperature in a light bulb.

To answer the second question, a minimum drop size of the melted spent fuel is achieved by preferably submitting the powdered UO₂ to an additional ultra fine grind to the talcum powder micron range. A one micron particle of UO₂ is approximately 3000 molecules in diameter. 4.5% or 135 of the molecules across the diameter of the spent fuel are the chemical species with very high vapor pressure at 3000° C. In this case, upon melting of spent nuclear fuel, a “popcorning” effect will be seen. A typical carrier gas velocity into the torch (10 feet/second and thickness of the plasma arc of say 0.1 feet) means the residence or heating time is in the order of 10 milliseconds—the liquid drop will be shattered. In this short time span the solid particle at ambient temperature will have been heated to 3000° C. and the collective vapor pressure of the chemical species will have generated a gas volume many times the size of the liquid drop. This gas production is at very rapid rates. This explosive effect enhances the transport of the volatile chemical species from the liquid to the helium/argon carrier gas. In which case, the separation of the chemical species (4.5%) from the spent uranium (95.5%) has been achieved.

In addition to the gasified chemical species the 3000° C. plasma gas flow now contains a mist of the ultra small liquid drops of the pure spent UO₂. The mist is preferably coalesced by use of a cyclone separator. Cyclone separators work on the difference between the density (grams/cubic centimeter) of the liquid drop and density of the carrier gas. In this case there is an extreme difference. The UO₂ is 10.96 g/cm³ and the carrier gas is (0.00018 g/cm³) at ambient temperature and 1/10 this value (0.000018 g/cm³) at 3000° C. The cyclone separator, with no moving parts, achieves the required demisting. This means the plasma gas phase will follow and turn with the flow volume allotted to it in a cyclonic manner and the ultra dense liquid drop will continue forward largely ignoring the centrifugal forces and collide directly with the wall of the vessel, will coalesce and in a circular manner flow down the walls under the influence of gravity.

The cyclonic flow imparted to the plasma gas phase will ensure that no liquid drops remain in the gas phase as the plasma gas, free of the spent UO₂, exits the separator in the vertical central pipe provided. The liquid, substaintially 100% spent UO₂, free of the chemical species, swirls down the walls to the drain in the bottom of the vessel.

Upon cooling, the solidified UO₂ (95.5% of the discharge from the system) would present no increased cross country transportation risk. This spent uranium would still be enriched in U²³⁵ to 0.92%. This enrichment would offer a more economic feed to the gaseous diffusion enrichment plant than natural uranium 0.711% and would reduce somewhat the natural uranium requirement. The depleted uranium tailings produced from this spent uranium would join the current storage of the previous tailings.

Alternative Methods to Cause Separation of the Chemical Species.

As an alternative embodiment, other systems could be utilized to provide the heat for separation according to this invention. In the broadest sense, evolving the chemical species from spent nuclear fuel requires only that the temperature of the spent fuel be raised above about 2,847° C. A readily understood description of a demonstration of the basic concept is a puddle of liquid spent nuclear fuel contained on a tungsten saucer that is heated by electrical resistance to this melting point temperature or slightly above. A small hole in the bottom of the dish gravity drains the dish at the same rate UO₂, preferably as a talc sized powder, is being added to the surface of the liquid. The more volatile chemical species are distilled from the surface of the liquid. A low temperature condenser creates a vacuum and pulls out the evolved vapor. The degasification could be on a continuous basis or in a batch mode.

The heat source could be electric resistance heating filaments inside the enclosure and adjacent the dish. The UO₂ filled dish would simmer until the chemical species had been boiled off and the purified UO₂ is then released to storage. In this degassing process no attempt is envisioned to segregate the chemical species. The entire quantity of condensed chemical species produced in the 18 months of operation of the 1000 MWe nuclear power plant and 30 days of processing would fit in a cube 2 feet on a side.

Disposition of the Chemical Species in the Helium/Argon Effluent.

This invention permits separation of the gaseous chemical species after they leave the enclosure. In the process of the preferred embodiment, using a plasma torch and a cyclone separator, the helium/argon plasma gas effluent contain all the chemical species in the vapor state at 3000° C. Since the xenon and krypton fission products condense several hundred degrees below 0° C. the plasma gas must be cooled to this temperature to liquefy and recover these radioactive gases. The temperature of the plasma gas will be reduced in stages. The dew points of the individual species will dictate when condensation occurs at each stage. Cyclonic flow will preferably be induced at each stage of cooling, thus the condensed phase will be separated and the liquid formed can be drained from each stage vessel. It is understood that a perfect separation of the individual chemical species will not be achieved. The helium or other plasma gas from the final stage is routed back to the plasma torch for reuse.

This partial separation technique is repeated until the cryogenic stages are reached. The stage the plutonium dioxide condenses will be given most careful design attention. This is because the plutonium fraction (about 22% of the non-UO₂ chemical constituents) is the largest component of the chemical species. Also, and most important, the manner with which the plutonium is physically managed and custody secured will establish the degree of risk of undesirable nuclear material proliferation.

Material Considerations.

The melting point of Uranium Dioxide (UO₂) is about 2,847° C. The 4.5% contaminants in the spent UO₂ fuel lowers the melting point some 170° C. This invention is predicated on processing the spent fuel at or above these very high temperatures. Few refractory materials are available that can contain the process at these temperatures. One such material is considered to be tungsten. The tungsten filament standard light bulb operates on the order of 3000° C. The physical properties, metallurgy and fabrication techniques of tungsten are widely and thoroughly understood. Tungsten pipes are routinely fabricated, usually with plasma arc deposition on a dissolvable surface. While the process temperature targeted is some 380° C. below the melting point, the metal's residual tensile strength is near zero at these high temperatures.

To add strength to the tungsten enclosure, two concentric tungsten pipes with an insulating layer between are provided to contain the plasma gas at 3000° C. The insulating layer is preferably thoria, (ThO₂, M.P. 3390° C.). The inner pipe carries near zero stress the thoria reduces the temperature some 200° C. for the outside pipe of tungsten, allowing the outer pipe to provide all the support. The pipe is boxed on four sides with flat pieces of pyrolytic graphite whose phenomenally low thermal conductivity will insulate the pipe to the degree required by the load carrying outer tungsten pipe. This suggested conceptual design allows the plasma gas to be conveyed within the pipe for an extended length beyond the plasma torch allowing the spent fuel drop suspended in the plasma gas to remain in the liquid state with sufficient time to degas.

The alternate method of effecting separation of the more volatile chemical species operates at the same temperatures. The simmering spent fuel in the electrically heated tungsten boat requires the same multi layer design considerations. The insulated dome above the simmering liquid UO₂ will not allow condensation on the inner surface of the dome by the boiled off effluent. The evolved gaseous chemical species will therefore exit the dome and enter the condenser. Pyrolytic graphite can be fabricated in a hemispherical shape and may, in addition to maintaining the temperature level, be able to also carry the load of the enclosure and related structure.

### OBJECTS OF THE INVENTION

Accordingly, a primary object of the present invention is to separate chemical constituents within spent nuclear reactor fuel from each other so that the separate chemical constituents can be most effectively separately handled.

Another object of the present invention is to provide a spent nuclear fuel chemical constituent separator which does not create additional radioactive waste.

Another object of the present invention is to provide a spent nuclear fuel chemical constituent separator which does not utilize liquid solvents.

Another object of the present invention is to provide a spent nuclear fuel chemical constituent separator which can achieve substantially complete separation of individual chemical constituents.

Another object of the present invention is to provide a method for separating spent nuclear fuel chemical constituents which is simple to operate, has a minimum of moving parts, and which can be effectively operated and controlled remotely with secure containment of the spent nuclear fuel during separation.

Another object of the present invention is to provide a separator for separating UO₂ from other chemical constituents within spent nuclear reactor fuel.

Another object of the present invention is to provide a cost effective alternative to long term storage of mixed spent nuclear reactor fuel.

Another object of the present invention is to provide a method for recycling UO₂ from spent nuclear reactor fuel for enrichment and reuse.

Another object of the present invention is to provide a method for extracting plutonium from spent nuclear reactor fuel for secure custody thereof by authorized personnel with low proliferation risk.

Other further objects of the present invention will become apparent from a careful reading of the included drawing figures, the claims and detailed description of the invention.

### BRIEF DESCRIPTION OF THE DRAWINGS

FIG. 1 is a flow chart illustrating the method of separating UO₂ and other chemical constituents within spent nuclear reactor fuel from each other, according to this invention.

FIG. 2 is a schematic full sectional view of a UO₂ separator and associated equipment for use according to the separation method of this invention with portions thereof conceptualized and/or adjusted in scale for convenience.

FIG. 3 is a schematic view of additional condensation separators for separating non-UO₂ chemical constituents of the spent nuclear fuel from each other.

FIG. 4 is a top plan view in full section of the UO₂ separator enclosure of FIG. 2 and illustrating one form of radiation shield insulation and sidewall form for the UO₂ separator enclosure.

FIG. 5 is an illustration providing a sub-microscoptic depiction of the micron sized particle of spent nuclear fuel passing through the electric arc of a plasma torch and being transformed in milliseconds to a liquid drop, with the drop evolving the more volatile chemical species contained therein.

FIG. 6 is front elevation view of an alternative separator enclosure shown in full section and depicting an alternative method for degassing the spent nuclear fuel. The powdered nuclear fuel is being fed to a tungsten boat. The boat contains a liquid level of simmering molter spent fuel. The tungsten boat is heated electrically. the volatile chemical species are seen evolving from the surface of the liquid and passing to a condenser. No helium gas or plasma torch is required with this embodiment.

### DESCRIPTION OF THE PREFERRED EMBODIMENT

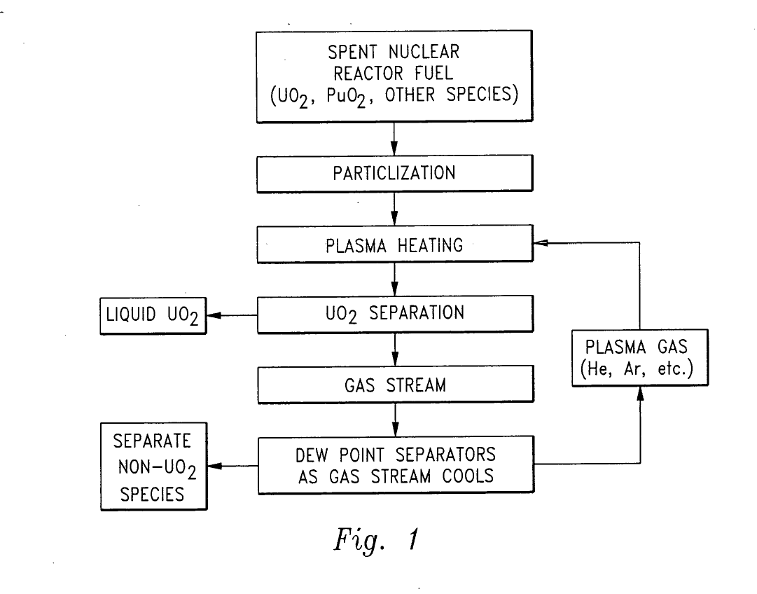

Referring to the drawings, wherein like reference numerals represent like parts throughout the various drawing figures, a non-aqueous method for separating chemical constituents in spent nuclear reactor fuel is described according to a preferred embodiment and various alternative embodiments. The spent nuclear reactor fuel F (FIG. 1) typically initially includes various isotopes of UO₂ as well as transuranic chemical constituents (actinides) and fission products. Once the fuel F has been separated according to this invention, preferably each of the chemical constituents have been separated from each other without generation of any additional radioactive waste, and particularly no contaminated solvents or other liquid waste.

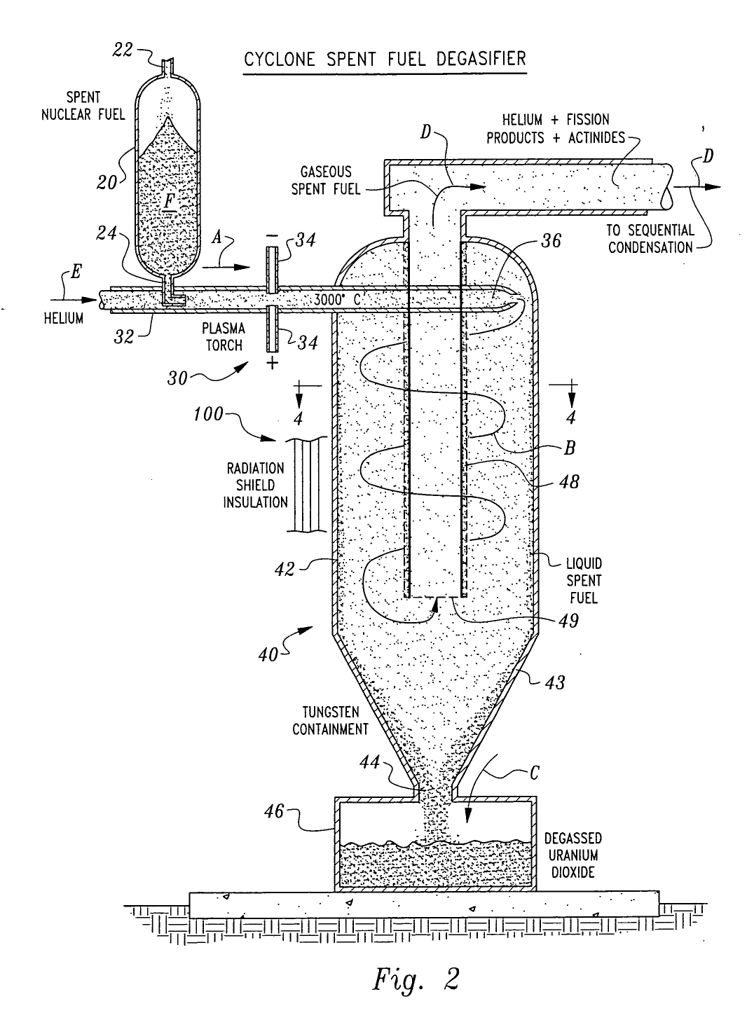

In essence, and with particular reference to FIG. 1, the basic steps in the separation method of this invention are described. The spent nuclear reactor fuel F is initially provided in the form of UO₂, plutonium dioxide (PuO₂) and various other chemical constituents including actinides and fission products. Preferably, this fuel F is particalized, such as by grinding into very fine small particles. These particles are then heated above a melting temperature of UO₂. Such heating preferably occurs by the particles being fed into a plasma torch (arrow A of FIG. 2) along with a plasma gas such as helium (arrow E of FIG. 2). The particalized spent nuclear fuel F and plasma gas are heated by arcing between electrodes 34 within the plasma torch 30 (FIG. 2) to a temperature above the melting point of UO₂ and above the boiling point of non-UO₂ chemical constituents of the fuel F. The fuel F is then entered into an enclosure such as the UO₂ separator enclosure 40. Within this enclosure 40, liquid UO₂ travels downward by force of gravity. A liquid outlet within the enclosure 40 removes the substantially pure liquid UO₂ from the separator enclosure 40. Gases within the enclosure 40 pass through a gas outlet. These gases include the plasma gas as well as the fission products and actinides.

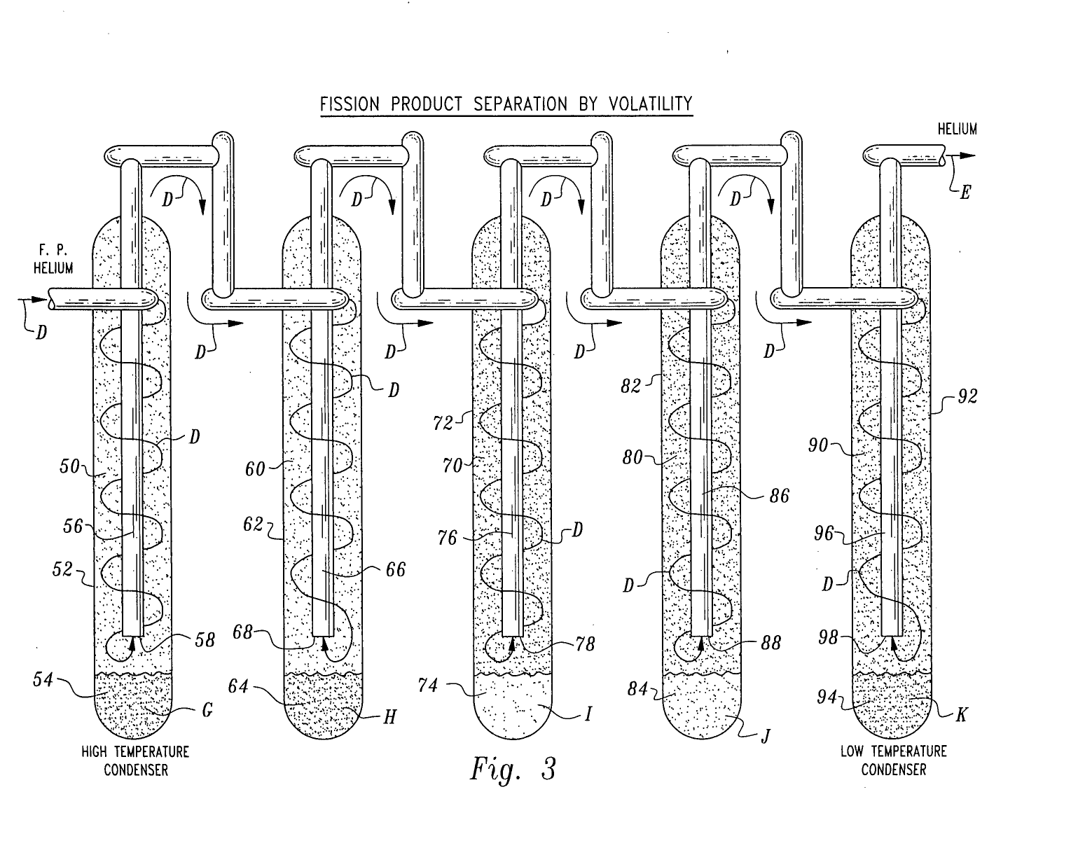

Most preferably, these gaseous chemical constituents of the fuel F are further separated by one or more additional separators in the form of condensation vessels. Each one of the separators 50, 60, 70, 80, 90 (FIG. 3) have a different temperature so that chemical constituents having different boiling temperatures are sequentially separated in liquid form within each one of the separators 50, 60, 70, 80, 90 until all of the chemical constituents of the fuel F have been separated and only the plasma gas remains. This plasma gas can then be recirculated to the plasma torch 30 for reuse (along arrow E of FIGS. 2 and 3).

More specifically, and with particular reference to FIG. 2, particular details of the separation method and exemplary equipment for use in performing the separation method of this invention are described. Typically, spent nuclear reactor fuel F is initially provided for separation in the form of a fuel rod containing a substantially homogeneous mixture of various isotopes of uranium dioxide, plutonium dioxide, other transuranic chemical constituents (actinides), either in the form of oxides or non-oxide elements, and fission products which may or may not be in the form of oxides.

To separate these chemical constituents according to this invention, the mixture of chemical constituents making up the spent nuclear fuel F must be heated to at least a melting temperature for UO₂. While any heating method capable of heating this mixture to at least the melting point of UO₂ (2,847° C.+/−30° C.) could be utilized, most preferably a plasma torch 30 is utilized to achieve such heating.

Before the plasma torch 30 can be effectively utilized, it is desirable to grind the fuel F in the form of a rod into fuel F in the form of fine particles. This particalization preferably grinds the fuel F into particles of one micron diameter or smaller. Such particalization facilitates passage of the solid particles through the plasma torch 30 where they are heated and boiled into a gas, or at least a liquid in the case of UO₂. If other forms of heating are utilized, such particalization can optionally be eliminated.

After particalization of the fuel F, the fuel F is preferably delivered into a hopper 20 for storage before separation according to this invention. The hopper 20 preferably includes an inlet 22 for receiving the particalized fuel F and an outlet 24 for delivering the particalized fuel F out into a supply tube 32 feeding the plasma torch 30.

The supply tube 32 preferably has a flow of plasma gas, such as helium or argon delivered thereinto (along arrow E of FIG. 2). The particles of fuel F are passed into this flow of plasma gas with a sufficient flow rate of the plasma gas that the particles of fuel F are caught up into the gas flow and discouraged from settling within the supply tube 32.

This supply tube 32 leads (along arrow A of FIG. 2) up to and past electrodes 34 of the plasma torch 30. The electrodes 34 have a high voltage therebetween sufficient to cause arcing and with the arcing delivering sufficient energy to the plasma gas and particalized fuel F passing therebetween to increase a temperature of the fuel F and plasma gas to at least above the melting point of UO₂ (2,847° C.+/−30° C.). Most preferably, the plasma torch 30 heats the fuel F and plasma gas to approximately 3,000° C. or higher. At such temperatures, even the UO₂ is potentially heated to above a vaporization temperature so that all of the fuel F and plasma gas are in a gaseous state.

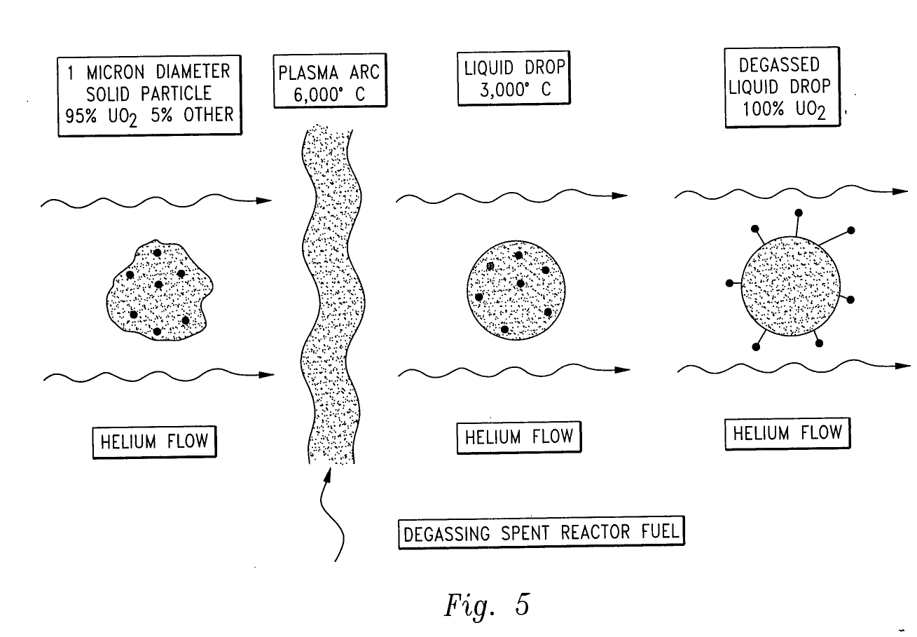

Details of the influence this heating has on the spent fuel are depicted in the illustration provided in FIG. 5. In particular, it is seen that the small particles begin as a solid mixture of mostly UO₂ with a small amount of other chemical constituents. After heating, the UO₂ into a liquid state, the other chemical constituents are sufficiently hot to be transformed into a gaseous phase. These bubble of gas in the UO₂ have a high vapor pressure and so are driven out of the drop of liquid UO₂. The stream thus includes a liquid drop of now substantially only UO₂ with the helium gas and other gaseous chemical constituents.

A discharge 36 downstream from the electrodes 34 of the plasma torch 30 extends into a UO₂ separator enclosure 40. The UO₂ separator enclosure 40 can have various different configurations, with a most preferred configuration shown in FIG. 2. This UO₂ separator enclosure 40 generally utilizes gravity forces to separate liquids from gases, generally in the form of a condenser separator. The enclosure 40 interior is maintained at a temperature at which UO₂ is in a liquid state and all non-UO₂ chemical constituents of the fuel F are in a gaseous state.

The UO₂ separator enclosure 40 includes a side wall 42 which is preferably generally cylindrical oriented about a vertical central axis. A lower portion of the enclosure 40 is preferably tapered along a taper 43 with a conical form leading down to a drain port 44 at a bottom of the enclosure 40. A UO₂ collector 46 is preferably located below the drain port 44 where liquid UO₂ is collected.

Preferably, the UO₂ is allowed to solidify within the UO₂ collector 46 by lowering the temperature thereof to below the UO₂ melting temperature. The UO₂ collector 46 can be configured to cast the liquid UO₂ into desired shapes for convenience in handling once the UO₂ solidifies, or otherwise be converted into an optimum form for handling in a solid phase.

The UO₂ separator enclosure 40 also includes a gas outlet preferably in the form of a stand pipe 48 aligned with a centerline of the enclosure 40. An entrance 49 at a bottom of the stand pipe 48 receives gaseous non-UO₂ chemical constituents of the fuel F for removal from the UO₂ separator enclosure 40.

While the UO₂ separator enclosure 40 could operate merely on the principal of gravity separation, preferably separation is further enhanced by generating cyclonic flow within the UO₂ separator enclosure 40. Specifically, the discharge 36 of the plasma torch 40 preferably enters the UO₂ separator 40 at an inlet which is offset laterally from the centerline of the UO₂ separator enclosure 40 and generally horizontally. Hence, the gas emitted from the discharge 36 and inlet into the UO₂ separator enclosure 40 is caused to swirl circumferentially within the generally cylindrical UO₂ separator enclosure 40.

Because the gas outlet from the UO₂ separator 40 is in the form of the entrance 49 at the bottom of the stand pipe 48, this circumferential flow tends downward so that the general path followed by the gaseous chemical constituents of the fuel F follows a helical path (along arrow B of FIG. 2). This helical path continues down until it gets below the entrance 49 at the bottom of the stand pipe 48. At this point, the flow tends toward the centerline of the UO₂ separator enclosure 40, and up into the entrance 49 and up the stand pipe 48.

Preferably, the side wall 42 of the enclosure 40 is maintained at approximately 3,000° C. with this temperature being sufficiently low to cause the UO₂ to condense into a liquid phase. If the UO₂ never boils into a gas, it exists as a fine droplet due to the particalization of the fuel F before passing through the plasma torch 30. These fine droplets or condensing gases of UO₂ will tend to collect on the walls of the enclosure 40, as heat transfer will tend to occur out through the walls 42 to a surrounding environment, causing the side wall 42 to be the coldest portion of the UO₂ separator enclosure 40. This condensing UO₂ liquid will travel by gravity down the side wall 42 to the taper 43 and down to the drain port 44 and into the UO₂ collector 46 (along arrow C of FIG. 2).

Preferably, the liquid UO₂ travels sufficiently slowly that any non-UO₂ gases entrained within the liquid UO₂ will have a sufficient opportunity to boil out of the liquid UO₂. Beneficially, the vapor pressures of UO₂ and the vapor pressures of other chemical constituents of the fuel F are such that substantially all of the non-UO₂ chemical constituents will boil out of the UO₂ liquid before the UO₂ liquid passes through the UO₂ drain port 44 and into the UO₂ collector 46. Preferably, the drain port 44 is sufficiently small and the flow of UO₂ sufficiently high that the drain port 44 is filled with liquid and prevents gaseous chemical constituents of the fuel F from passing into the UO₂ collector 46 through the drain port 44.

Another advantage of the orientation of the stand pipe 48 for the gaseous outlet from the UO₂ separator 40, in addition to generating cyclonic flow for enhanced separation, is its tendency to avoid gas stratification within the UO₂ separator enclosure 40. In particular, one gaseous chemical constituent within the UO₂ separator enclosure 40 is plutonium oxide (PuO₂). PuO₂ and other transuranic chemical constituents of the fuel F are relatively heavy gases at this temperature and so would tend to settle toward a lower portion of the UO₂ separator 40.

If the gaseous outlet from the UO₂ separator 40 were at a top of the UO₂ separator enclosure 40, a tendency might exist for PuO₂ or other transuranic gaseous chemical constituents to stagnate near a lower portion of the UO₂ separator enclosure 40. By spacing the inlet into the UO₂ separator enclosure 40 in the form of the discharge 36 near an upper portion of the UO₂ separator enclosure 40, and with the gaseous outlet in the form of the entrance 49 into the stand pipe 48 spaced vertically from each other and with somewhat turbulent cyclonic flow therebetween, the gases within the UO₂ separator enclosure 40 remain sufficiently stirred that such stratification and stagnation of gases within the UO₂ separator enclosure 40 is resisted. Also, the stand pipe 48 discourages liquid UO₂ escape therethrough should the level of UO₂ liquid rise to an unacceptably high level.

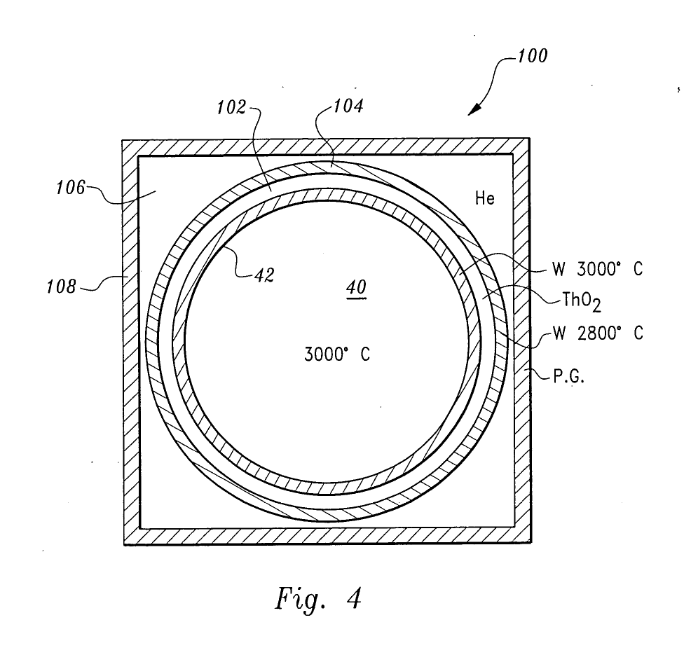

With particular reference to FIG. 4, further details of the UO₂ separator enclosure 40 are described. In particular, a containment structure 100 is provided surrounding the UO₂ separator enclosure 40. Initially, the side wall 42 is provided defining an interior space of the UO₂ separator enclosure 40 which is preferably maintained at approximately 3,000° C. An innermost portion of the side wall 42 is preferably in the form of tungsten metal which would typically have a temperature close to but slightly less than 3,000° C. Preferably, this innermost layer of tungsten metal is surrounded by a layer 102 of thorium oxide. Thorium oxide exhibits both the ability to withstand high temperatures and a low rate of thermal conductivity, such that heat transfer out of the enclosure 40 is discouraged. Preferably, a second layer 104 of tungsten is provided outside of the layer of thorium oxide which would then be at approximately 2,800° C.

Outside of this second tungsten layer, preferably a gas region 106 is placed to provide further insulation for the enclosure 40. This gas region 106 is preferably filled with helium or other non-reactive gases to prevent degradation of the tungsten or other metals forming the separator, and also to exhibit little performance degradation in the high radiation environment involved.

Preferably, this gas space is contained adjacent the enclosure 40 by an outer enclosure 108 of pyrolytic graphite. Pyrolytic graphite has a low thermal conductivity and thermal radiation properties which further discourage heat transfer out of the separator enclosure 40. The containment structure 100 both acts to maintain the fuel F while undergoing separation, while also discouraging heat transfer beyond a desirable rate out of the UO₂ separator enclosure 40, and while also providing some degree of radiation shielding for a surrounding environment. This containment structure 100 provides a preferred form of containment structure, with various different modifications being acceptable provided that desired rates of heat transfer are provided and appropriate levels of radiation shielding are provided.

With particular reference to FIG. 3, details of additional separators for the non-UO₂ chemical constituents of the fuel F are described. While spent nuclear reactor fuel F is largely UO₂, making efficient removal of UO₂ from other chemical constituents of first importance, it is desirable that the remaining gaseous chemical constituents of the fuel F also be separated from each other for optimal handling. To provide such separation, preferably a series of dew point separators are provided generally in the form of condensation vessels maintained at progressively lower temperatures downstream from the gas outlet from the UO₂ separator enclosure 40.

In particular, gas flow occurs along arrow D of FIGS. 2 and 3 through the various separators 50, 60, 70, 80, 90. Each of these separators is preferably similar to the UO₂ separator enclosure 40, except that these other separators 50, 60, 70, 80, 90 would typically be smaller and could optionally omit the liquid outlet, and rather merely allow liquids to collect within lower portions of each of the separators 50, 60, 70, 80, 90 for later removal when the system is off line. The second separator 50 provides a first such dew point condensation separator and preferably includes a vessel wall 52 which maintains a temperature within the second separator 50 which is below a condensation point of at least one non-UO₂ chemical constituent of the fuel F. In the second separator 50 one or more chemical constituents G, typically PuO₂, would collect as a liquid within a collection region 54 at a lower portion of the separator 50.

The gas pipe 56 is preferably oriented generally as a stand pipe aligned with a vertical centerline of the vessel wall 52 with an entrance 58 at a lowermost end of the gas pipe 56. Thus, cyclonic flow within the second separator 50 can beneficially enhance separation within the second separator 50.

Gas flow into the entrance 58 follows arrows D to a third separator 60 in the preferred embodiment of this invention. The number of separators provided can vary depending on the degree of separation desired. Most preferably, a third separator 60 has a similar form to the second separator 50. Hence, the third separator 60 includes a vessel wall 62, collection region 64, gas pipe 66 and entrance 68. One or more chemical constituents H having a lower condensation temperature than the chemical constituents G collect within the collection region 64 of the second separator 60.

A fourth separator 70 is preferably located downstream from the third separator 60. The fourth separator preferably similarly includes a vessel wall 72, collection region 74, gas pipe 76 and entrance 78. The fourth separator 70 thus causes one or more chemical constituents I to collect in the collection region. The chemical constituents I would be characterized by having a condensation temperature below that of the chemical constituent H.

Preferably, a fifth separator 80 is located downstream from the fourth separator 70. The fifth separator 80 is similar to the other separators 50, 60, 70 such that it includes a vessel wall 82, collection region 84, gas pipe 86 and entrance 88. The collection region 84 collects one or more chemical constituents J which are characterized by having a condensation temperature below the condensation temperature for chemical constituents I.

Finally, according to the preferred embodiment, a sixth separator 90 is preferably provided downstream from the fifth separator 80. The sixth separator 90 preferably similarly includes a vessel wall 92, collection region 94, gas pipe 96 and entrance 98. One or more chemical constituents K collect within the collection region 94 with the chemical constituents K characterized by having a condensation temperature lower than that of the chemical constituents J. Preferably, only the plasma gas remains in gaseous form within the sixth separator 90. This plasma gas exits through the gas pipe 96 (along arrow E of FIG. 3) where it can be recycled to the supply tube 36 of the plasma torch 30 (FIG. 2).

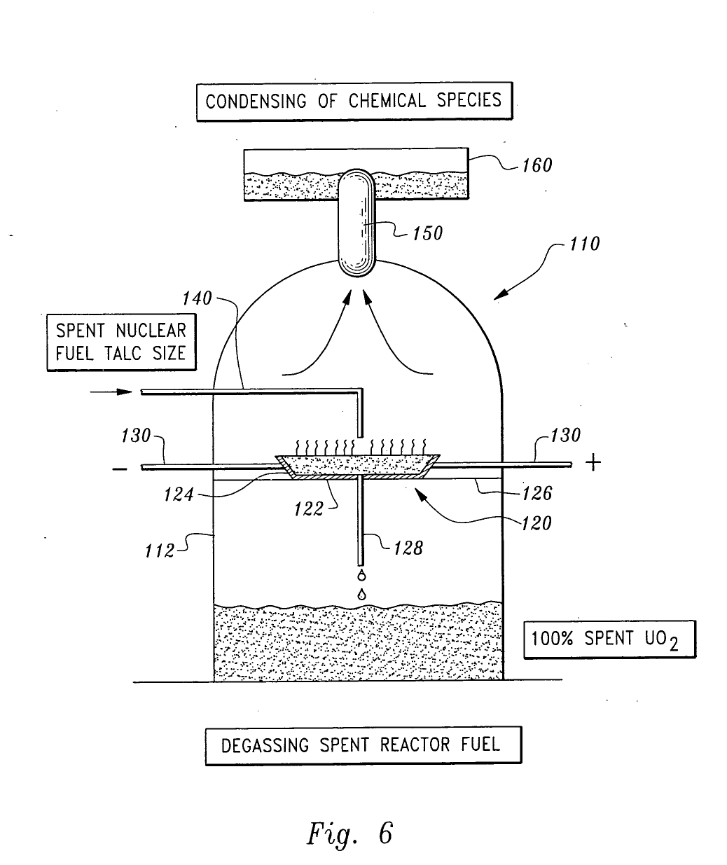

With reference to FIG. 6, details of an alternative heater and heating method are described. An alternative enclosure 110 is provided which is generally analogous to the separator enclosure 40 of the preferred embodiment, except as distinguished herein. A sidewall 112 provides for containment of the UO₂ and other chemical constituents being processed. With this alternative heater, a boat 120 is located inside the enclosure 110. The boat 120 holds the liquid UO₂ while the gaseous other chemical constituents bubble out of the liquid UO₂.

The boat 120 preferably includes a floor 122 surrounded by a rim 124 to contain the liquid UO2. The boat 120 can have any of a variety of particular shapes, with the shape depicted in FIG. 6 merely exemplary. The boat 120 rests upon a shelf 126. A drain 128 allows liquid UO₂ from the bottom of the boat 120 to drain out of the boat 120 for collection at a bottom of the enclosure 110.

The entire enclosure is sufficiently hot that none of the other chemical species driven out of the liquid UO₂ condense on the sidewall 112. The gaseous chemical species thus are contained within the enclosure 110 until they escape out of the enclosure 110 through the top vent 150.

The boat 120 and UO₂ therein can be heated in many ways. Most preferably, resistance heating electrodes 130 are provided for such heating. These electrodes 130 can be in contact with the boat 120 for conduction heating, or be adjacent, but spaced from the boat 120, so that heating is primarily by heat radiation. The boat 120 is made of a material, such as tungsten, which can remain solid and with sufficient strength at the temperatures involved (2,847° C.+/−30° C.).

The spent fuel is preferably ground to a powder, such as to particle sizes of one micron or less, before being fed into the enclosure 110 through a spent fuel feed pipe 140 and into the boat 120. Alternatively, the spent fuel could be provided in larger particle sizes, or even in rod form, provided the boat 120 or other liquid UO₂ holder can handle the larger sizes. This alternative heater could operate continuously, or in a batch fashion. The top vent 150 is preferably coupled to a series of chemical species separators 160. These separators 160 preferably are arranged similarly to the various separators provided downstream of the separator enclosure 40 of the preferred embodiment.

Once the various different chemical constituents of the spent nuclear reactor fuel F have been separated from each other, they can be separately handled in a manner which is optimal for each separate chemical constituent. For instance, the UO₂ could beneficially be reused in nuclear reactors after reprocessing, such that less uranium would need to be mined to power nuclear reactors. The plutonium dioxide could be processed for use as a fuel in nuclear reactors, or beneficially transmuted into other isotopes, or safely stored in a secure area for non-proliferation.

Some of the remaining chemical constituents can be grouped by associated levels of radioactivity and half lives, such that those chemical constituents having relatively short half lives can be stored at progressively less sensitive disposal sites over time. Those chemical constituents having longer half lives can be placed in more long term storage, with only a small amount of such storage then being necessary because only the appropriately long half life chemical constituents require such storage. Also, many chemical constituents may have a valid market therefore, such as to power fluoroscopes and medical diagnostic equipment, for use in radiological medicine, for beneficial use in research, and in other applications where such chemical constituents are in demand.

It is contemplated that when a nuclear power plant is undergoing refueling, that space would be set aside at each nuclear power facility where the separation equipment for practicing the separation method of this invention would be utilized. This equipment could be permanently provided on site or be provided in a mobile fashion for use at various different nuclear power plants or other nuclear facilities. Most preferably; common teams of operators would utilize mobile equipment on site to separate the spent nuclear reactor fuel on site at the various spent nuclear reactor fuel generating facilities. Such handling experts would then deliver constituents having market value into the marketplace, distribute low value constituents into properly sequestered storage on site at the facility, and deliver chemical constituents such as the uranium dioxide and plutonium dioxide to facilities where reprocessing and/or secure storage can occur.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of connection, unless specifically restricted.

What is claimed is:

1- A method for separating chemical constituents in spent nuclear fuel, the spent nuclear fuel including uranium dioxide and other chemical constituents, the method including the steps of:
heating the spent nuclear fuel to a temperature at least as high as a vaporization temperature for all chemical constituents in the spent nuclear fuel except uranium dioxide; and
separating liquid uranium dioxide from gaseous non-uranium dioxide spent nuclear fuel chemical constituents.

2- The method of claim 1 including the further step of particalizing the spent nuclear fuel before said heating step, said particalizing step including the step of reducing the spent nuclear fuel into particles at least as small as [ten micrometers—Jack please verify] across.

3- The method of claim 1 wherein said particalizing step includes the step of grinding the spent nuclear fuel in solid form to particles of desired smaller size.

4- The method of claim 1 wherein said heating step includes the step of utilizing a plasma torch to heat the spent nuclear fuel.

5- The method of claim 4 wherein said heating step includes the step of heating the spent nuclear fuel to a temperature above a vaporization temperature for all of the spent nuclear fuel chemical constituents including uranium dioxide.

6- The method of claim 1 including the further step of adding plasma gas to the spent nuclear fuel after said particalizing step and before said heating step, and recirculating plasma gas downstream from an enclosure which accomplishes said separating step, such that said plasma gas can be recirculated.

7- The method of claim 6 wherein said plasma gas includes helium.

8- The method of claim 6 wherein said plasma gas includes argon.

9- The method of claim 1 wherein said separating step includes the step of spacing outlets from a separator vertically such that separation by gravity occurs.

10- The method of claim 1 wherein said separating step includes the step of configuring a separator enclosure as a cyclone separator with a generally helical vortex of wind for removal of uranium dioxide spent nuclear fuel chemical constituents from the separator.

11- The method of claim 1 wherein said separating step includes the step of passing gaseous non-uranium dioxide spent nuclear fuel chemical constituents to at least one separate enclosure downstream from a first enclosure where uranium dioxide is separated, allowing the spent nuclear fuel to cool to a condensation temperature for at least one of the non-uranium dioxide chemical constituents in the spent nuclear fuel, and further separating liquid chemical constituents from gaseous chemical constituents within the spent nuclear fuel.

12- The method of claim 11 including the further step of repeating said passing step at a lower temperature to further remove liquid chemical constituents from gaseous chemical constituents remaining within the spent nuclear fuel.

13- The method of claim 12 including the step of further repeating said passing step at least three more times at consecutively lower temperatures and with each of said separate enclosures removing at least one separate liquid chemical constituent within the spent nuclear fuel.

14- A system for separating chemical constituents within spent nuclear fuel based on the vaporization temperature of the chemical constituents, the system comprising in combination:
a heater, said heater including an inlet for spent nuclear fuel including uranium dioxide, an outlet for liquid uranium dioxide and an outlet for gaseous chemical constituents in the spent nuclear fuel;
said heater adapted to heat the spent nuclear fuel including uranium dioxide to a temperature at least as high as a vaporization temperature for all chemical constituents in the spent nuclear fuel except uranium dioxide and above a liquification temperature for the uranium dioxide, such that the uranium dioxide is at least heated into a liquid phase and the non-uranium dioxide chemical constituents within the spent nuclear fuel are vaporized into a gaseous phase; and
a separator located downstream from said heater, said separator including a gas outlet and a liquid outlet therein.

15- The system of claim 14 wherein said separator includes a separation region between said inlet and said liquid outlet and said gaseous outlet.

16- The system of claim 14 wherein said gas outlet is coupled to at least one condensation separator downstream from said gas outlet, said at least one separator adapted to have a lesser temperature than the temperature of the spent nuclear fuel at said heater by a sufficient amount that at least one chemical constituent within the spent nuclear fuel condenses into a liquid for separation from other portions of the spent nuclear fuel which remain gaseous.

17- The system of claim 16 wherein at least five separators are coupled to each other and to the gas outlet of said separator, each of said separators having a different temperature and with each consecutive separator coupled to a gas outlet of the previous separator.

18- The system of claim 14 wherein said heater includes a plasma torch adapted to heat the spent nuclear fuel to at least 2,800° C.

19- The system of claim 18 wherein said gas outlet and said liquid outlet are located within an enclosure which is generally cylindrical in shape with said liquid outlet at a bottom thereof and with said gas outlet located within a lower end of a substantially vertically tube oriented near a centerline of said enclosure.

20- The system of claim 14 wherein a particalizer is located upstream from said heater and downstream from the source of spent nuclear fuel, the particalizer sizing the spent nuclear fuel with particle sizes sufficiently small to allow rapid heating of all of the spent nuclear fuel.

21- The system of claim 20 wherein said heater includes a plasma torch.

22- The system of claim 21 wherein said heater includes a source of plasma gas with the particalized spent nuclear fuel carried by the plasma gas past the plasma torch where heating of the spent nuclear fuel occurs.

23- A separator for chemical constituents in spent nuclear fuel including uranium dioxide, the separator comprising in combination:
an enclosure;
an inlet for the spent nuclear fuel;
said inlet adapted to deliver the spent nuclear fuel into said enclosure at a temperature and pressure at which uranium dioxide is a fluid and other chemical constituents are gaseous;
a liquid outlet;
said liquid outlet adapted to remove primarily uranium dioxide from said enclosure;
a gas outlet; and
said gas outlet adapted to remove non-uranium dioxide chemical constituents from said enclosure.

24- The separator of claim 23 wherein said inlet is adapted to deliver uranium dioxide and other chemical constituents into said enclosure as a gas mixture, at least portions of said enclosure cooler than a condensation temperature of the uranium dioxide, such that uranium dioxide condenses into a liquid within said enclosure.

25- The separator of claim 24 wherein said separator includes a heater upstream from said inlet of said enclosure, said heater adapted to heat the spent nuclear fuel to a temperature at which non-uranium dioxide chemical constituents are gaseous.

26- The separator of claim 25 wherein said heater includes a plasma torch with a plasma gas inlet adapted to deliver a plasma gas into said heater upstream of said plasma torch and a fuel inlet for particalized spent nuclear fuel located upstream of said plasma torch.

27- The separator of claim 23 wherein said liquid outlet is located at a lower end of said enclosure.

28- The separator of claim 27 wherein said enclosure is substantially cylindrical in form with a centerline oriented substantially vertically, and wherein said inlet is offset laterally from said centerline with said gas outlet substantially aligned with said centerline of said enclosure, such that gas flow out of said inlet and into said enclosure creates cyclonic gas flow between said inlet and said gas outlet.

29- The separator of claim 23 wherein said enclosure includes walls which are at least partially formed of tungsten metal with said walls having a melting point higher than a melting point for uranium dioxide, and with said enclosure maintained at a temperature between a melting point of said walls and the melting point of uranium dioxide.

30- The separator of claim 29 wherein said walls of said enclosure include thorium dioxide therein.

31- The separator of claim 29 wherein said walls of said enclosure include pyrolytic graphite therein.

32- The separator of claim 23 wherein said gas outlet is coupled to at least one condensation vessel, said vessel adapted to have a temperature and pressure at which at least one non-uranium dioxide chemical constituent of the spent nuclear fuel is a liquid and at least one chemical constituent of the spent nuclear fuel is a gas, said vessel including a secondary gas outlet for chemical constituents of the spent nuclear fuel which remain gaseous within said condensation vessel.

33- The separator of claim 32 wherein said condensation vessel is substantially cylindrical with a vessel inlet coupled to said gas outlet of said enclosure, said vessel inlet oriented offset laterally from a centerline of said vessel, and with said secondary gas outlet of said vessel substantially aligned with said centerline of said condensation vessel, such that cyclonic gas flow is induced between said vessel inlet and said secondary gas outlet within said vessel.

34- The separator of claim 23 wherein said inlet is adapted to deliver the spent nuclear fuel into said enclosure at a temperature and pressure at which uranium dioxide is a liquid and other chemical constituents of the spent nuclear fuel are gaseous.
